(19) United States
(12) Patent Application Publication
(10) Pub. No.: US 2004/0237338 A1
(43) Pub. Date: Dec. 2, 2004

(54) Tumble-dryer and method for treating clothes

(76) Inventors: Hanns Rump, Hausen (DE); Olaf Kiesewetter, Geschwenda (DE); Rainer Klein, Mosbach (DE); Uwe Koziol, Dortmund (DE); Jessica Gerhart, Hausen (DE)

Correspondence Address: Michael L Greenberg, Greenberg & Lieberman, 314 Philadelphia Avenue, Takoma Park, MD, 20912, US

(21) Appl. No.: 10/466,319

(22) PCT Filed: Jan. 30, 2002
(86) PCT No.: PCT/DE02/00317

(30) Foreign Application Priority Data
Jan. 30, 2001 (DE) 101 03 905.0

(51) Int. Cl. F26B 11/02

(52) U.S. Cl. 34/607

(57) ABSTRACT

The invention relates to a tumble-drier and to a process that allows complete or partial sterilization or passivation of microorganisms and germs in laundry. To this end, the laundry is treated in a container (5), especially the drum of a tumble-drier, to which a stream of air is supplied for the purpose of drying the laundry. Ozone is added to said supply air stream. This ozone is preferably generated by an ozone generator (6) directly before being added to the supply air stream. The tumble-drier according to the invention comprises a container (5) for laundry, especially a drum, to which an air stream is supplied for the purpose of drying the laundry, and an ozone generator that is capable of adding ozone to the supply air stream. Said ozone generator is preferably an ozone generator working according to the principle of dielectric impeded discharge.

The invention refers to a tumble-drier with a container for laundry, in which for the purpose of the drying process of the laundry a supply air stream is introduceable, in accordance with the preamble of claim 1. Likewise the invention refers to a process for treating laundry in accordance with the preamble of claim 16.

### STATE OF THE ART

Ozone, the triatomic of oxygen (O₃), is used favourably in numerous technical applications. In aerial engineering applications e.g. ozone airborne germs and, in addition, oxidizeable gases and dampness and smells are oxidatively destroyed. In water-technical applications (like drinking water, swimming pool) ozone in small quantities of for instance 1-2 g/m3 is solved in water with the aim of preventing biological activities in the water and of killing germs, as well as to oxidatively destroy water solved organic substances. In this weak concentration of 1-2 ppm parts by weight in aqueous solution there is no toxic effect concerning humans and no aggressive effect concerning materials, although germs are killed after on the average 10 minutes and the ability of biological material to reproduce is substantially prevented.

Ozone is the most reactive oxidizing substance with very high effectiveness against all oxidizeable substances and in relation to germs of all kinds.

The technical production of ozone takes place mostly in electrical discharge apparatuses, which work according to the physical principle “dielectrically impeded discharge” (“Siemens tube”).

Newer ozone generators are not developed any more according to the classical principle of a tube, but often as flat multilevel dielectric assembly in planar technique.

Currently used common state of the art of ozone production and of the electrical control of the ozone generators is described for example in DE 100 14 485,3, DE 100 13 841,1, DE 100 04 326,7, DE 199 33 180,4, DE 199 31 366,0, DE 199 19 623,0.

Modern washing methods and modem detergents have made it possible to lower the washing temperature and the quantity of water ever more. Although the optical washing result and the ability to extract and wash out dirt from the laundry became better and better, no heat sterilisation of the laundry takes place because of the small washing temperature. The number of germs in the laundry rises as can be proved. The hygienic washing result becomes objectively worse.

This leads to the fact that as metabolic side-effect of different germs a specific “muggy smell” of the laundry is to be determined, if the laundry is not treated in the last washing course with so-called “fabric softeners”, that contain perfume amongst other things. The mentioned muggy smell is covered with active smells, but there is no effect on the number of germs.

Technical Task:

Therefore the task underlying the invention is to provide a tumble-drier and a process, which make it possible to sterilize or passivate micro organisms and germs in laundry completely or partly.

Disclosure of the Invention and its Advantages:

This task is solved according to the invention by a tumble-drier with a container for laundry, in particular a drum, in which for the purpose of the drying process of the laundry a supply air stream is introduceable, and which is characterized by an ozone generator, which is able to add ozone to the supply air stream.

Furthermore the task is solved by a process for treating laundry, which is in a container, in particular a drum, of a tumble-drier, whereby for the purpose of the treatment, in particular for the drying process of the laundry, a supply air stream is introduceable into the container, characterized in that ozone is added to the supply air stream, which is produced by an ozone generator before it is led into the supply air stream. In another embodiment ozone is first in an receiver, from which it is released slowly into the air stream, so that ozone in this case can be produced by an ozone producer, which is apart from the place of the laundry drying process.

Beside the above mentioned applications in the field of aerial engineering equipment, and some industrial applications, this invention suggests using ozone favourably in electrical tumble-driers. This, because modem washing processes and modern detergents made it possible to lower the washing temperature and the quantity of water more and more. Although the optical washing result and the ability to extract and wash out dirt from the laundry became better and better, no heat sterilisation of the laundry takes place because of the low washing temperature. The number of the germs in the laundry rises proveably. The hygienic wash result becomes objectively worse.

This leads to the fact that as metabolic side-effect of different germs a specific “muggy smell” of the laundry is to be determined, if the laundry is not treated in the last washing course with so-called “fabric softeners”, that contain perfume amongst other things. The mentioned muggy smell is covered with active smells, but there is no effect on the number of germs.

According to the invention it is suggested to add ozone to the drying air. The ozone production is made preferably electrically according to the principle of dielectrically impeded discharge. Preferably, compact flat modules are used as ozone generators. The ozone quantity produced in the system is typically in a range between 50-200 mg/h, which results in ozone concentrations of for instance 0,5-1 ppm, taking into account permanent ozone decay and the presence of wet laundry.

Ozone supplied with the air heated up of the still wet laundry adsorbs partially on the surface of the laundry. During this, complex chemical effect mechanisms arise:

While in the pure gaseous phase with the given ozone concentrations of typically less than 1 ppm almost no chemical oxidative reactions of airborne gases or germs arise with ozone, ozone molecules adsorbed on the surfaces accumulate in large quantity (agglomeration). During this process dense adsorbates with thicknesses of several molecules and thus very high local ozone concentrations are reached, what likewise enables chemical reactions with oxidizeable adsorbates attached on the laundry and also with germs attached on the surface.

A large part of the ozone solves in the water, which is contained in the wet fabric. 4,94 ml (or approx. 10 mg) ozone can be solved in 1000 ml water. Highly reactive hydro radicals, like O₂H, O₃H, or O₂R (R=org. residue), are produced in this process, which produce oxygen in the singlet status during their recombination:

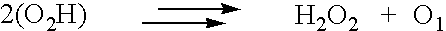

With this ozonolyse organic compounds and even fatty acids will be cracked, protein will become denatured and cracked highly effectively, under formation of Ozonides, bacteria and viruses will be destroyed or biologically passivated, respectively. So the method according to the invention secures favourably that germs, protein remainders and chemical substances (organic substances) bearing smell, attached to the laundry are destroyed oxidatively or are at least passivated. After the ozone treatment the laundry is hygienically perfect in every respect.

The invention can be used in particular for the treatment of hospital laundry and contribute to reduce the danger of hospital-internal cross infections.

The supply air stream is preferably warmed up for the acceleration of the drying process. The tumble-drier therefore preferably contains an air heater, which is able to warm up the supply air stream.

In a favourable arrangement the supply air stream consists of two partial air streams, i.e. a main air stream and a auxiliary air stream, whereby in the auxiliary air stream a smaller amount of air per time unit streams than in the main air stream and the ozone generator is arranged in one of the two partial air streams.

The ozone generator can be arranged in the auxiliary air stream and a filter can be arranged in the auxiliary air stream, which filters particles from the auxiliary air stream. In this case the auxiliary air stream is led through the filter. In this case it is preferable that the main air stream does not have to pass a filter and the ozone generator is nevertheless protected against contamination e.g. by fluff balls and dust.

For the execution of the invention in the context of this invention further suggestions are made, which affect the result advantageously:

During the drying process naturally the amount of water in the laundry is reduced close to zero. With dry laundry only the surface effect is relevant in connection with ozone, because ozone deposits (adsorbs) on the surfaces of textiles. During the wet phase during the above described “ozonolyse” process germs and smells have been destroyed highly effective, so that a further ozone treatment of the dry fabric is in principle ineffective. In addition, if the ozonization process would be continued to the end of the drying process, the laundry finally taken out would have adsorbed ozone, which would be transferred to the environment by and by through desorption processes. Since ozone is smellable already in very small concentrations of <30-40 ppb, this would be a disadvantage.

Therefore it is suggested according to the invention to accomplish the ozonisation preferentially only in the first phase of the drying process during which the laundry is still wet.

In accordance with an advantageous embodiment the ozone generator is therefore switched off, if the dampness of the laundry or of air diverting from the same is smaller than a given threshold value. For this purpose the tumble-drier contains a dampness sensor, which detects the dampness of the laundry or of the air diverting from the laundry and switches off the ozone generator or activates a deactivation of the ozone generator, if this dampness is less than a given threshold value.

In accordance with another embodiment the ozone generator is automatically switched off after a given period of time after the beginning of the laundry drying process and still before the end of the same. For this purpose the tumble-drier can contain an interval timer, which is able to switch off the ozone generator after a given length of time after the start of the laundry drying process. Preferably the supply air stream is maintained and heated for a certain time interval after switch-off of the ozone generator.

It is prevented by these embodiments that laundry, which is already dry, is ozonized. These control methods prevent favourably that a quite high ozone concentration is formed inside the equipment, because, if the laundry is wet, a large portion of produced ozone is let out of the gaseous phase into the aqueous solution. It is further favourable that by an early switch-off close to the end of the drying process practically no more ozone is present inside the equipment. Smelling nuisances by ozone can therefore not take place any longer.

In accordance with a further embodiment the container comprises a loading hatch, which can be closed, whereby the ozone generator can be activated only with a closed loading hatch and the tumble-drier comprises a circuit breaker, which is able to switch off the ozone generator before or when opening the loading hatch by force. With tumble-driers, with which the opening of the loading hatch is released by an electrical switch, which can be operated from the outside, the circuit breaker can be activated in parallel by this electrical switch.

In accordance with a further embodiment the container has a loading hatch, which can be closed, with an opening mechanism with a blocking device, which is able to block the opening mechanism when the ozone generator is working, so that opening of the loading hatch is only possible when the ozone generator is switched off. In this way it is prevented that the ozone generator constantly produces ozone with opened loading hatch and delivers the ozone out of the hatch opening.

In accordance with another embodiment the container has a loading hatch, which can be closed, with an opening mechanism with a blocking device, whereby an actuation of the opening mechanism causes a switch off of the ozone generator, and whereby the blocking device with switched on ozone generator as well as after switching off of the ozone generator still blocks the opening mechanism for a given idle time and releases it only thereafter.

In accordance with a further embodiment the blocking of the opening mechanism is released only when the ozone generator is switched off and at least a given waiting period (idle time) has elapsed after its switching off. For this purpose the blocking device can be able—e.g. with the help of a delay circuit—to block the opening mechanism after switching off the ozone generator still for a given waiting period and to release it only thereafter, so that opening of the loading hatch after switching off the ozone generator is possible only after expiration of the waiting period.

Preferably the supply air stream is both maintained further and heated for a certain time span after switching off the ozone generator. In this embodiment the tumble-drier is capable of maintaining the supply air stream as well as the air heater for a certain time period after switching off the ozone.

It can occur that with lengthy downtimes and/or with sudden humidity increases during operation dampness can settle as condensate on the ozonization module. This can lead to malfunction of the ozone generator. According to the invention it is therefore suggested, that the ozone generator is heated.

Therefore in accordance with an advantageous embodiment the ozone generator is warmed up by a heating element to such a high temperature that no condensation takes place on the ozone generator. For this purpose the ozone generator can be heatable by means of a heating element above the dew point temperature.

Preferably, the temperature of the ozone generator is regulated in this connection, whereby a temperature setpoint is given, which is higher than the dew point temperature. For this purpose the tumble-drier can contain a temperature regulator, which is connected to the heating element and to a temperature sensor arranged at or in the ozone generator and which is able to regulate the temperature of the ozone generator by influencing the heating power of the heating element. In particular the heating element can be an electrical resistance, which is connected thermoconductively to the ozone generator.

The ozone production is effected preferentially by means of compact, flat modules according to the principle of dielectrically impeded discharge according to the DE 199 31 366.0. The ozone generator is preferably exhibiting two electrodes, between which a high voltage of a high-energy unit is applied and between which at least two dielectrics are situated. Ozone is therefore preferably produced by an ozone generator, which exhibits two electrodes, between which a high voltage is applied and between which at least two dielectrics are situated, and which is operated according to the principle of dielectrically impeded discharge.

The temperature sensor and/or the heating element can be e.g. a conductive structure, in particular made of platinum, which is applied on, and especially vapour deposited on, one of the dielectrics.

### SHORT DESCRIPTION OF THE FIGURES, WHICH SHOW

FIG. 1 a schematic representation of a tumble-drier according to invention,

FIG. 2 a schematic timetable for a laundry drying process according to the invention,

FIG. 3 a schematic block diagram for regulation of the damp of a tumble-drier in accordance with an embodiment of the invention, and

FIG. 4 a schematic representation of an embodiment of a well-known ozone generator, which is additionally provided with a conductive structure serving as temperature sensor.

### WAYS OF THE EXECUTION OF THE INVENTION

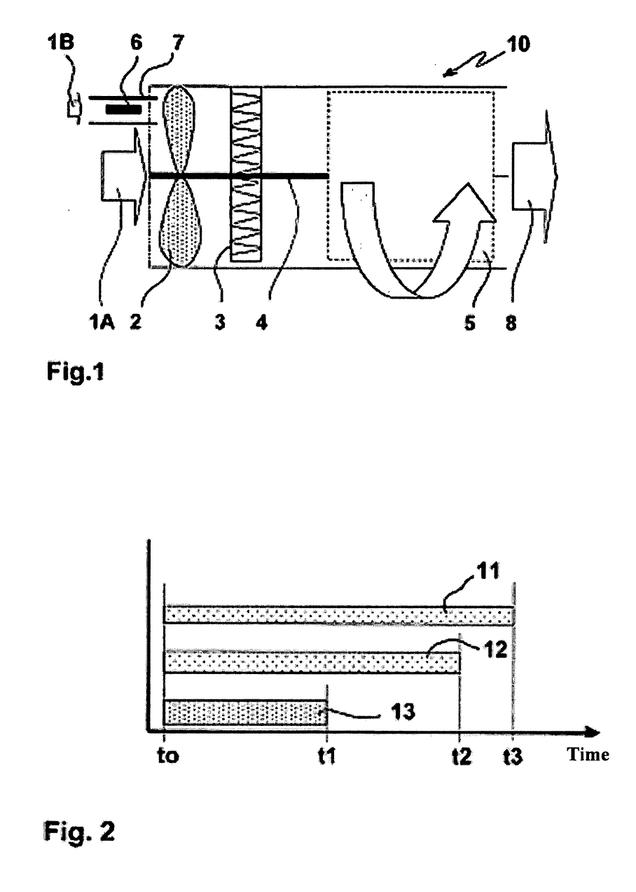

Electrical tumble-driers are used increasingly world-wide. FIG. 1 schematically shows an embodiment of a tumble-drier according to the invention 10, with an ozone generator 6 with two electrodes (not shown in FIG. 1). Between the two electrodes there is applied a high voltage of a high-energy unit (not shown in FIG. 1) by corresponding, supply lines which are not shown.

The laundry, which has to be dried, is strongly aired in a rotatable drum 5 or in rotatable drums 5 by the help of supply air, whereby the air, which is transported through the system by efficient fans 2, is heated up in heating elements 3. The supply air enters the tumble-drier in two partial air streams 1A, 1B, i.e. in a main air stream 1A and in a auxiliary air stream 1B, both of which are driven by the fan 2. The auxiliary air stream 1B streams through a pipe 7, which contains the ozone generator 6 and is thereby enriched with ozone, before entry into the drum 5 in contrast to the main air stream 1A. Both partial air streams 1A, 1B are swirled by the fan 2 and to a large extent mixed homogeneously. For example a filter can be arranged in the range of the air inlet side of the pipe 7, which filters particles from the auxiliary air stream and therefore protects the ozone generator 6 against dirt. Such a filter can also be arranged in the region of the air outlet end of the pipe 7 in order to prevent e.g. at standstills of the fan 2 a diffusion of dust or fluff balls into the pipe 7. After streaming through the drum 5 the air leaves the tumble-drier as exhaust air stream 8. The drum is often on the same shaft 4 with the wings of the fan, so that with just one engine both the drum is turned and the fan is moved. After some time the dried laundry can be taken out.

The ozone generator can be situated in the main stream of internally transported air. That poses the disadvantage, that textile fluff balls and other particles can settle on the surface of the ozone generator and hamper its function in the long run. Therefore, according to the invention it is suggested to arrange the ozone generator preferably in an auxiliary air stream, as is shown in an embodiment in FIG. 1.

In the auxiliary air stream—which has to transport only a fraction of the air stream—according to a preferred embodiment of the invention efficient particle filters prevent, that this disadvantageous effect can occur. It is without any systematic importance whether the auxiliary air stream has its own fan, which leads ozonized air to the main stream, or whether a part of the air is transported in the particle-cleaned auxiliary air stream by skilled utilization of pressure differences resulting inside the equipment.

Simple systems just blow the heated air through the laundry moving inside the drum 5, whereby the damp hot exhaust air 8 is simply led outward. More elaborate systems work using an air technical circular flow, whereby the humidity is extracted from the air by condensers (cooled surfaces) according to the principle of condensation and buffered in a container, which is to be emptied after the drying process.

According to the invention it is suggested to add ozone to the drying air. The ozone production is effected preferably according to the principle of dielectrically impeded discharge. Compact flat modules are preferably used as ozone generators. The ozone quantity produced in the system is typical in a range between 50-200 mg/h, which results in ozone concentrations of for instance 0,5-1 ppm during permanent decay of ozone and during the presence of wet laundry.

The ozone generator 6 in FIG. 1 is arranged in front of the fan or in front of the ventilator 2, respectively. In another embodiment (not shown), the ozone generator 6 is arranged between the fan 2 and the air heater 3, in another different embodiment (not shown) between the air heater 3 and the drum 5. The turbulence produced by the ventilator 2 also provides a mixing of the supply air stream with the main air stream in these embodiments.

Ozone supplied to the wet laundry with the heated air adsorbs partially on the surface of the laundry. Complex chemical effect mechanisms arise:

Whereas in the pure gaseous phase with given ozone concentrations of typically less than 1 ppm almost no chemical oxidative reactions of airborne gases or germs with ozone take place, ozone molecules adsorbed on the surfaces however accumulate in large quantity (agglomeration). Dense adsorbates of several molecule thicknesses and thus very high local ozone concentrations are achieved, which likewise enables chemical reactions with oxidizeable adsorbates attached to the laundry and also with germs attached to the surface.

A large amount of the ozone solves in the water, which is contained in wet fabric, which is to be dried, (4,94 ml (or approx. 10 mg) ozone solves in 1000 ml water). Highly reactive hydro radicals, like O₂H, O₃H, or O₂R (R=org. residual) are produced during this process, which produce oxygen in the singlet state during their recombination:

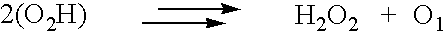

During this ozonolysis organic compounds and even fatty acids are cracked, protein will become denatured and likewise be cracked highly effectively under formation of ozonides, bacteria and viruses are destroyed and/or biologically passivated.

So the method according to the invention advantageously ensures that germs, protein remainders and chemical substances (organic substances) bearing smell, attached to the laundry are destroyed oxidatively or are at least passivated. After the ozone treatment the laundry is hygienically perfect in every respect.

For the execution of the invention in the context of this invention further suggestions are made, positively affecting the result:.

During the drying process naturally the amount of water in the laundry is reduced to close to zero. In the case of dry laundry only the surface effect is relevant in connection with ozone, because ozone deposits (adsorbs) on the surfaces of textiles. During the wet phase during the above described “ozonolyse” process germs and smells have been destroyed highly effective, so that a further ozone treatment of the dry fabric is in principle ineffective. In addition, if the ozonization process would be continued to the end of the drying process, the laundry finally taken out would have adsorbed ozone, which would be transferred to the environment by and by through desorption processes. Since ozone is smellable already in very small concentrations of <30-40 ppb, this would be a disadvantage. Therefore, it is suggested according to invention to execute the ozonization preferably only in the first phase of the drying process, when the laundry is still wet. The control can be made using several methods:

a) Time Controlled:

FIG. 2 shows the time sequence of a typical application: The activation range of the fan and of the drum 11, the activation range of the electrical air heating 12 and the activation range of the ozonization 13. By switching on the drying process the blower fan, the air heating, the drum engine and also the ozone generator are activated. The fan, the air heater and the ozone generator are activated at the same time in accordance with the embodiment of FIG. 2 at the beginning of the laundry drying process.

After a time period, in which approximately 80% of the dampness that is bonded to the laundry has evaporated, the ozone generator is switched off. The ozone generator is switched off at a time t1, which is preferably chosen such, that about 80% of the dampness that is bonded to the laundry has evaporated, whereas the ventilator, the rotation of the drum and the air heater are kept going beyond the time t1.

Thus the ozone generator is automatically switched off after a predefined time period after the start of the laundry drying process and still before the end of it. The tumble-drier preferably contains a timer, which is capable of switching off the ozone generator automatically after a given length of time after beginning of the laundry drying procedure and still before end of the same. It is possible to use a timer, which is present in conventional tumble-driers for the regulation of the time sequence in the first place anyway, so that there is no need for an additional timer for the time regulation of the ozone production. The rest of the drying time is completed in a conventional manner. The hydroxides and the adsorbed ozone molecules detach from the laundry and disintegrate to diatomic, molecular oxygen O₂. The laundry is hygienically perfect and advantageously carries no more adsorbed ozone.

At a time t2 after the time t1 in the embodiment of FIG. 2 the air heater is turned on, while the fan as well as the rotation of the drum are kept going after the time t2. At a still later time t3 the fan as well as the rotation of the drum are finally switched off.

b) Dampness-Controlled:

In a dampness-controlled embodiment a tumble-drier according to the invention contains a dampness sensor, which is able to detect the dampness of the laundry or of the air diverting from the laundry and then, if this amount of dampness is smaller than a given threshold value, to switch off the ozone generator or activate a deactivation of the ozone generator.

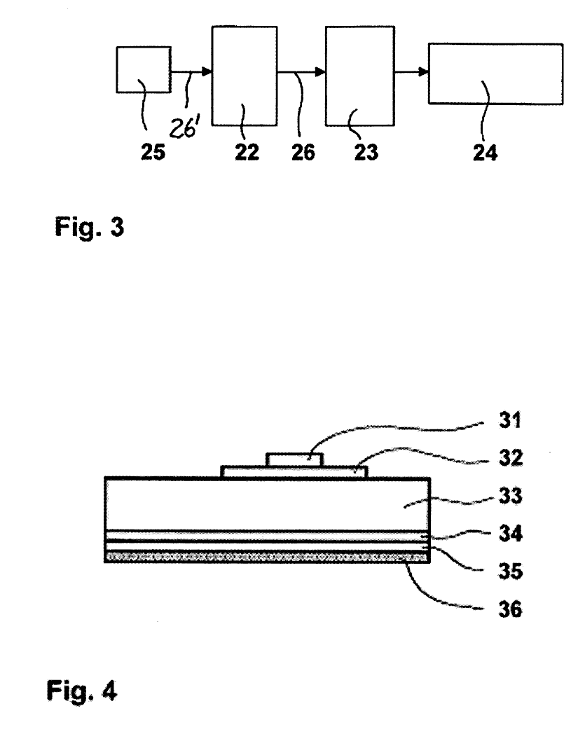

FIG. 3 shows a schematic block diagram for a dampness control of a tumble-drier in accordance with an embodiment of the invention with a dampness sensor 25, a central control and command equipment 22, an ozone generator 24 and a controllable high voltage supply 23, which is capable of supplying the ozone generator 24 with high voltage.

Many modern drying devices contain sensors, which determine the dampness of the laundry. This can be accomplished by the measurement of the relative dampness of the air by means of hygrometers, but also by means of electrical measurement of the conductivity of the laundry; wet laundry conducts, dry laundry is an insulator. In these cases the existing dampness sensor can be used as dampness sensor 25, FIG. 3, so that for the dampness control of the ozone production no additional dampness sensor is necessary. The dampness sensor 25 of FIG. 3 therefore can be an already implemented or a re-fitted dampness sensor.

Furthermore in many conventional tumble-driers a control equipment is present, too, which controls one or more conventional functions of the tumble-drier and is capable of working as a control and command equipment 22 (FIG. 3), in which case advantageously no additional control and command equipment for the dampness control of the ozone production is necessary. The command and controller equipment 22 of FIG. 3 can therefore be an already existing or a re-fitted control equipment.

A refitting of conventional tumble-driers to a tumble-drier according to the invention is therefore possible in many cases at small expenditure.

According to FIG. 3 an electrical connection 26, 26′ is installed between the central control and command equipment 22 of the tumble-drier, the sensors 25 and the high-energy unit 23, which drives the ozonization module 24.

The dampness sensor 25 detects the amount of dampness of the laundry or of the air diverting from the laundry in accordance with the embodiment of FIG. 3 and, if this amount of dampness is smaller than a given threshold value, a switching signal is delivered to the control and command equipment 22. This thereupon delivers a switching signal to the high-energy unit 23, by which it is caused to switch off the high voltage so that the ozone generator 24 receives no more high voltage and thereby is switched off.

In accordance with another embodiment not shown a dampness sensor is directly connected to the high-energy unit and able to cause this to disconnect the high voltage, if the measured amount of dampness falls below the threshold value without a control and command equipment involved. These embodiments are the based upon the consideration, that the ozonization is switched off if the relative amount of dampness in the inner air stream circuit or the relative amount of dampness of the exhaust air 8, FIG. 1, or if the conductance of the laundry falls below a certain given value. As a result, it is prevented that already dry laundry is ozonized, too.

These control methods advantageously prevent that very high ozone concentrations can occur inside the equipment. Because if the laundry is wet, a large portion of produced ozone changes from the gaseous phase into the aqueous solution. In the case of a given ozone production of approx. 50-100 mg/h and in the case of a given natural disintegration rate of ozone, i.e. half-life period within the range of a few minutes in the presence of high air temperatures and high air humidity, ozone concentrations within the range of typically 0,5-1 ppm in the case of wet laundry result, which correspond to only a few microgramm of airborne ozone at a volume of approx. 50 litres. Ozone is present less in air than rather in a weak concentration in aqueous solution.

With dry laundry the air-bound ozone concentration can however increase in the equipment up to values of 3-5 ppm. This is not only ineffective regarding the desired aim, but can have unfavourable long term effects on surfaces and on technical components that are in contact with ozone.

It is further advantageous, that at early deactivation before the end of the drying process practically no more ozone is kept inside the equipment. Bad smell caused by ozone cannot take place any longer.

Occasionally the drying process is interrupted by the user, for example in order to insert a further piece of laundry into the drum. If there is a very high ozone production inside the equipment, ozone can get through the open hatch into the surrounding. Even if there are 50 litres of air with a very high ozone concentration of e.g. 10 ppm in the equipment, it would—when mixed with approx. 10,000 litres of room air—result in an ozone concentration of harmless, however smellable 0,05 ppb at worst, since all device functions—also the production of ozone—are interrupted when opening the hatch.

In order to lower the ozone quantity present in the interior of the equipment even more, it is suggested according to the invention that after activation of the instruction to open the hatch this instruction is not implemented immediately, but that only production of ozone is interrupted immediately and that air heating and air transport though the laundry is continued for approx. 1 minute. If the hatch is opened after this period of time, ozone present inside the equipment to a large extent is solved or disintegrated.

It can occur that with lengthy downtimes and/or with sudden humidity increases during operation dampness can settle as condensate on the ozonization module. This by an influence on the dielectric constants leads to the fact, that no more discharges take place and no more ozone is produced.

In order to prevent this situation, the ozone generator is heatable by means of a heating element above the dew point temperature in accordance with an embodiment of the invention. The heating element can especially be an electrical resistance, which is actuated by a filament current and thermally conductingly connected to the ozone generator. It is suggested according to the invention, that an electrical resistance functioning as heating be thermally coupled with the ozonization module. The formation of condensate is reliably avoided by increase of the dew point. In practical execution this takes place e.g. via cementing an electrical resistance under current to the ceramic(s) module of the ozonisators.

In accordance with a preferable embodiment the ozone generator contains two electrodes, which are connected to a high voltage of a high voltage supply and between which at least two dielectrics are positioned and which work according to the principle of dielectrically impeded discharge. The production of ozone is effected preferentially in compact, flat modules according to the principle of electrically impeded discharge according to the theory of the DE 199 31 366.0.

In a preferred embodiment the tumble-drier comprises a temperature regulator, which is connected to the heating element and to a temperature sensor arranged at or in the ozone generator and which is able to regulate the temperature of the ozone generator by influencing of the heating power of the heating element. The temperature sensor can be built as a conductive structure, in particular made of platinum, which is applied on, and in particular vapour-deposited on, one of the dielectrics.

FIG. 4 shows a schematic presentation of an embodiment of such an ozone generator, which is additionally provided with a conductive structure 36 serving as temperature sensor. The ozone generator of FIG. 4 comprises a substrate 33, which consists of a first dielectric and carries on its one main face a layer 32 consisting of a different, second dielectric, which only partly covers the main face of the substrate 33. On this layer a strip electrode 31 is arranged in such a way that the second dielectric 32 is arranged between the strip electrode 31 and the carrier 33. On the opposite main face of the carrier 33 a counter electrode 34 is arranged. This is followed by a glass layer 35, which serves as insulator and protection for the counter electrode 34.

In accordance with an embodiment of the invention a conductive structure 36 is therefore additionally arranged on the back of a such an ozone generator made of a vapour-deposited metal, preferably of platinum. This conductor serves as a temperature sensor due to the well-known dependence temperature/platinum resistance. The electrical resistance of the conductive structure 36 is measured by not shown conductive lines. By a suitable electrical circuit it is ensured that the temperature of the ozonization module is always operated some degrees above the dew point.

In accordance with another embodiment the counter electrode 34 is used at the same time as a temperature sensor, so that the separate conductive structure 36 can be avoided. In accordance with a further embodiment the counter electrode 34 is used as a temperature sensor, while the separate conductive structure 36 is under filament current and is used as heating element.

Industrial Applicability:

The invention is industrially applicable for a device for the purpose of drying of laundry, which has a rotatable drum which can take the laundry, an air heating and an air fan, which drives the heated air through the drum and thereby through the laundry which is to be dried. In the air stream an ozonization equipment is inserted, so that the air is enriched with ozone. Thus favourably by the chemical mechanism of the oxidation, germs, smells and organic substances carried by the laundry are destroyed and/or passivated. In particular the invention is commercially applicable in hospitals and nursing homes.

List of the Reference Symbols:

1A main air stream

1B auxiliary air stream

2 fan

3 air heater

4 shaft

5 drum

6,24 ozone generator

7 pipe

8 exhaust air stream

10 tumble-drier, tumble-drier

11 switch-on time of the fan

12 switch-on time of the air heater

13 switch-on time of the ozone generator

22 control and command equipment

23 high-energy unit

25 dampness sensor

26,26′ connections

31 strip electrode

32 second dielectric

33 first dielectric

34 back electrode

35 glass layer

36 conductive structure

t1 point of down time of the fan

t2 point of down time of the air heater

t3 point of down time of the ozone generator

1. Tumble-drier with a container for laundry, in particular a drum (5), in which a supply air stream is introduceable for the purpose of the drying process of the laundry, characterized by an ozone generator (6,24), which is capable of adding ozone to the supply air stream.

2. Tumble-drier according to claim 1, characterized in that the tumble-drier contains an air heater (3), which is able to warm up the supply air stream.

3. Tumble-drier according to one of claims 1 or 2, characterized in that the supply air stream consists of two partial air streams, i.e. a main air stream (1A) and an auxiliary air stream (1B), whereby in the auxiliary air stream (1B) a smaller amount of air is flowing per time unit than in the main air stream (1A) and the ozone generator (6,24) is arranged in one of the two partial air streams (1A, 1b).

4. Tumble-drier according to claim 3, characterized in that the ozone generator (6,24) is arranged in the auxiliary air stream (1B) and a filter is arranged in the auxiliary air stream, which filters particles from the auxiliary air stream (1B).

5. Tumble-drier according to at least one of claims 1 to 4, characterized in that it contains a dampness sensor, which is able to detect the amount of dampness of the laundry or air diverting from the laundry and then, if this amount of air is smaller than a given threshold value, to switch off the ozone generator (6,24) or to activate a deactivation of the ozone generator (6,24).

6. Tumble-drier according to at least one of claims 1 to 5, characterized in that it contains an interval timer, which is able to switch off the ozone generator (6,24) after a given period of time (T1) after the start of the laundry drying process.

7. Tumble-drier according to at least one of claims 1 to 6, characterized in that the container (5) contains a loading hatch, which can be closed, whereby the ozone generator (6,24) can be activated only with a closed loading hatch and the tumble-drier (10) covers a re-fitter, which forces the ozone generator to switch off (6,24) before or when opening the loading hatch.

8. Tumble-drier according to at least one of claims 1 to 7, characterized in that the container (5) contains a loading hatch, which can be closed, with an opening mechanism with a blocking device, which is able to block the opening mechanism when the ozone generator (6,24) is working so that opening of the loading hatch is only possible when the ozone generator (6,24) is switched off.

9. Tumble-drier according to claim 8, characterized in that the blocking is able to block and release the opening mechanism only after switching off of the ozone generator (6,24) after a given idle time so that opening of the loading hatch after switching off of the ozone generator (6,24) is possible only after expiration of the idle time.

10. Tumble-drier according to claim 2 and one of claims 5 to 9, characterized in that the tumble-drier is able to keep the supply air stream and the air heater (3) going after switching off of the ozone generator (10) for a certain period of time.

11. Tumble-drier according to at least one of the preceding claims, characterized in that the ozone generator is heatable above the dew point temperature by means of a heating element.

12. Tumble-drier according to claim 11, characterized in that the tumble-drier contains a temperature regulator, which is connected to the heating element and to a temperature sensor, which is arranged at or in the ozone generator (6,24) and is able to regulate the temperature of the ozone generator (6,24) by influencing the heating power of the heating element.

13. Tumble-drier according to claims 11 or 12, characterized in that the heating element is an electrical resistance, which is connected thermoconductively to the ozone generator (6,24).

14. Tumble-drier according to claim 1, characterized in that the ozone generator (6,24) exhibits two electrodes, between which a high voltage of a high-energy unit (23) is applied and between which at least two dielectrics are situated, and which works according to the principle of dielectrically impeded discharge.

15. Tumble-drier according to claims 12 and 14, characterized in that the temperature sensor and/or the heating element are a conductive structure, in particular made of platinum, which is applied on, especially vapour-deposited on, one of the dielectrics.

16. Process for treating laundry, which is arranged in a container, in particular a drum (5) of a tumble-drier, whereby for the purpose of the treatment, in particular for the drying of the laundry, a supply air stream is introduceable into the container, characterized in that ozone is added to the supply air stream, which is produced by an ozone generator (6,24) before it is led into the supply air stream.

17. Process according to claim 16, characterized in that ozone is present in a pressurestorage tank at first, from which it is released slowly into the supply air stream.

18. Process according to claim 16, characterized in that the ozone generator (6,24) exhibits two electrodes, between which a high voltage is applied and between which at least two dielectrics are situated, and which works according to the principle of dielectrically impeded discharge.

19. Process according to claims 16 to 18, characterized in that the supply air stream is maintained and still heated for a certain period of time after switching off the ozone generator (6,24).

20. Process according to claims 16 to 19, characterized in that the container (5) exhibits a loading hatch, which can be closed, with an opening mechanism with a blocking device, whereby an activation of the opening mechanism causes a switching off of the ozone generator (6,24) and the blocking device blocks the opening mechanism for a given idle time when the ozone generator (6,24) is switched on as well as after switching off the ozone generator (6,24) and releases it only afterwards.

21. Process according to at least one of claims 16 to 20, characterized in that the ozone generator (6,24) is warmed up by a heating element to a such a high temperature that no condensation takes place on the ozone generator (6,24).

22. Process according to claim 21, characterized in that the temperature of the ozone generator (6,24) is regulated.
